(19) United States
(12) Patent Application Publication
(10) Pub. No.: US 2019/0287126 A1
(43) Pub. Date: Sep. 19, 2019

(54) NETWORK COMPUTING SYSTEM DEPLOYING TREATMENT CONTENT FOR AN APPLICATION-BASED SERVICE

(71) Applicant: Uber Technologies, Inc., San Francisco, CA (US)

(72) Inventors: Yefei Peng, San Francisco, CA (US); Haowei Zhang, San Francisco, CA (US); James Lee, San Francisco, CA (US); Weiwei Shen, San Franciscco, CA (US); Shuyang Du, San Francisco, CA (US); Yi Zheng, San Francisco, CA (US); Minh Pham, San Francisco, CA (US)

(21) Appl. No.: 15/922,624

(22) Filed: Mar. 15, 2018

(51) Int. Cl. G06Q 30/02; H04L 29/08

(52) U.S. Cl. CPC G06Q 30/0207; H04L 67/18; H04L 67/16; H04L 67/141

(57) ABSTRACT

A computing system can detect a session trigger corresponding to execution of a service application on a computing device of a user, the session trigger initiating a user session of an application-based service. The system can execute one or more of a plurality of models corresponding to a unique objective for the application-based service, wherein each model runs real-time session data corresponding to the user session. The system can generate, from each model of the plurality of models, a session score indicating a priority level for the unique objective corresponding to the model. Based on the session score from each of the plurality of models, the system can transmit treatment data to the computing device of the user, the treatment data causing treatment content to be displayed on the computing device of the user.

### BACKGROUND

For service applications executable by computing devices of a user base, user growth and retention can involve incentive programs, such as discounts, rebates, special offers, free services, and the like.

### BRIEF DESCRIPTION OF THE DRAWINGS

The disclosure herein is illustrated by way of example, and not by way of limitation, in the figures of the accompanying drawings in which like reference numerals refer to similar elements, and in which:

FIG. 1A is a block diagram illustrating an example network computing system implementing a predictive sub-system for an application-based service, according to one or more examples described herein;

FIG. 1B is a block diagram illustrating a predictive sub-system of a network computing system, according to examples described herein;

FIG. 2 illustrates a computing device of a user of the application-based service, according to one or more examples described herein;

FIG. 3 is a flow chart describing example method of implementing an application-based service utilizing deployed treatment content, according various examples described herein; and

FIG. 4 is a block diagram that illustrates a computer system upon which examples described herein may be implemented.

### DETAILED DESCRIPTION

Examples described herein relate to a network computing system implementing a set of models (e.g., machine learning models) that account for real-time contextual information in providing treatment content and features to users of an application-based service (e.g., an on-demand transport service). In certain examples, the models can each represent a unique objective for the application-based service, such as a target match rate for a particular transport service type (e.g., a carpool service), a retention rate or conversion for users, balancing transport supply distribution across sub-regions, and the like.

Given real-time session data of a user, each model can output a score. The network computing system can utilize the outputted scores from the models to personalize the in-app experience of the user. For example, the model scores can indicate the priorities of the application-based service, which the network computing system can take into account when selecting and providing treatment content to be displayed on the user's computing device. As provided herein, the treatment content can include incentives, discounted offers for the transport service or specific transport service types, service credits, promotional services, and the like, with the goal of meeting the objectives represented by the models.

In some examples, the network computing system implements an on-demand transport service that matches transport providers with requesting users. The network computing system can receive real-time contextual data (e.g., session data) corresponding to the user, such as the user's current location, a time of day, a day of the week, proximate locales (e.g., parks, stores, restaurants, etc.), proximate roads, and the like. As provided herein, a session trigger can correspond to the user launching the service application on the user's computing device, which can cause the computing device to transmit real-time information to the network computing system (e.g., location data).

Furthermore, the network computing system can collect and store user profile data corresponding to the user's personal usage of the application-based service, such as which particular transport types the user typically requests (e.g., carpool service, standard ride-share service, luxury vehicle service, professional car service, large capacity vehicle service, etc.), a level of cost consciousness of the user, a punctuality factor, sensitivity to quality, and the like. Accordingly, the network computing system can store a user profile indicating user preferences and tendencies. The contextual data run through the models can therefore include real-time data corresponding to the user, as well as profile data collected and stored by the network computing system.

In various implementations, the network computing system can provide treatment content in accordance with a set of stop limits, such as a budgetary limit (e.g., a budget expense rate limit), a supply/demand balance limit for each sub-region in the transport service region, and the like. For example, the service entity can include an incentive budget and a set of supply/demand balancing goals for each transport service type within the transport service region. In providing treatment content to users, the network computing system can effectively aid in redistributing transport supply between sub-regions (e.g., seeking to homogenize transport supply versus demand between sub-regions). In additional example, the treatment content can be deployed to users within a particular sub-region based on marketplace balance (e.g., transport supply versus transport demand for a particular transport service option, such as carpool ride sharing). Accordingly, given the incentive budget, the network computing system can target specific transport service incentives by providing individually tailored treatment content to users to encourage user growth, retention, and conversion, with an added goal of balancing the marketplace between transport providers and requesting users.

As used herein, a user device, a requesting user device, a provider device, and/or a computing device refer to devices corresponding to desktop computers, cellular devices or smartphones, laptop computers, tablet devices, wearable devices, and other connected devices that can provide network connectivity and processing resources for communicating with a network computing system over a network. A provider device can also correspond to custom hardware, in-vehicle devices, or on-board computers of a vehicle operated by a service provider, etc. The user device and/or the provider device can also operate a respective service application that is configured to communicate with the network computing system, in context of, for example, providing on-demand services.

While some examples described herein relate to on-demand transport services, the service arrangement system can enable other on-demand location-based services (for example, a food truck service, a delivery service, an entertainment service) to be arranged between individuals and service providers. For example, a user can request an on-demand service, such as a delivery service (e.g., food delivery, messenger service, food truck service, or product shipping) or an entertainment service (e.g., mariachi band, string quartet) using the system, and the system can select a service provider, such as a driver, food provider, band, etc., to provide the on-demand service for the user.

One or more embodiments described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more embodiments described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some embodiments described herein can generally require the use of computing devices, including processing and memory resources. For example, one or more embodiments described herein may be implemented, in whole or in part, on computing devices such as servers, desktop computers, cellular or smartphones, tablets, wearable electronic devices, laptop computers, printers, digital picture frames, network equipment (e.g., routers) and tablet devices. Memory, processing, and network resources may all be used in connection with the establishment, use, or performance of any embodiment described herein (including with the performance of any method or with the implementation of any system).

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, embodiments may be implemented in the form of computer-programs, or a computer usable carrier medium capable of carrying such a program.

System Description

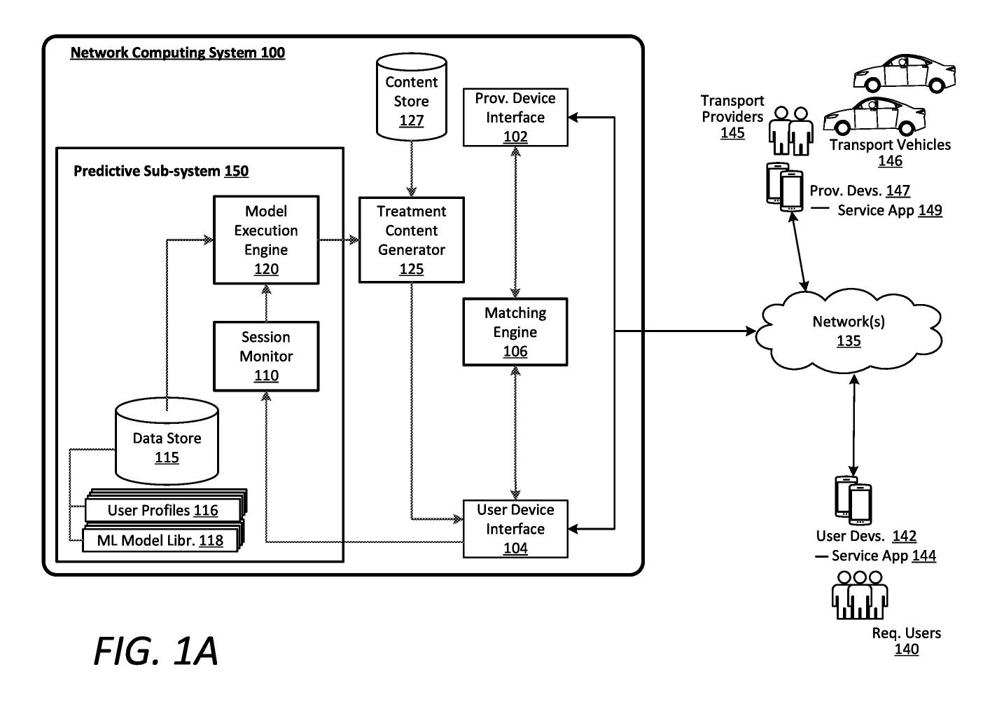

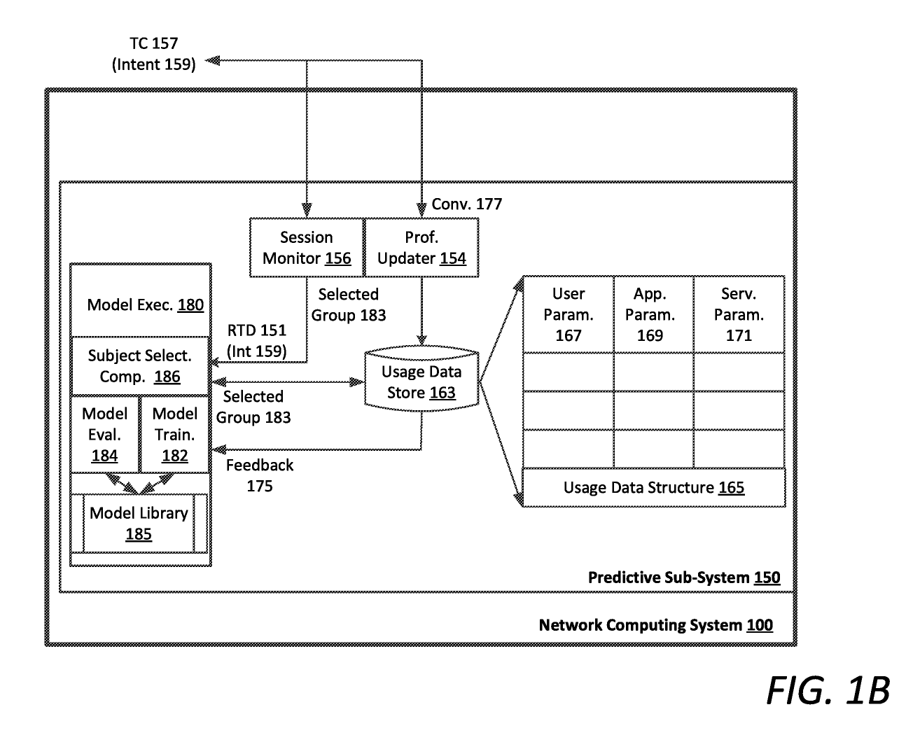

FIG. 1A is a block diagram illustrating a network computing system implementing a predictive-subsystem for an application-based service, according to one or more examples described herein. As described, a network computing system 100 may be implemented to provide a network service, such as an on-demand transportation service that manages transportation for users, and/or product delivery or comestible goods to users. Accordingly, the system 100 may be implemented on, for example, one or more servers or other network computer machines. In some examples, the system 100 is implemented as part of an on-demand transport arrangement service, which operates to match incoming transport service requests from requesting user devices 142 with transport service providers who are available and in proximity to a rendezvous location of the transport request. In variations, the system 100 can be implemented as a separate or standalone service that can interface with a transportation arrangement service or user devices (e.g., via an executing service application for the network service). Additionally or alternatively, the system 100 can be implemented at least in part on individual user devices 142. For example, functionality described with the system 100 may be implemented as part of a service application 144 that runs on mobile devices 142 of individual requesting users 140.

In an example of FIG. 1A, the network computing system 100 is shown to be in communication with provider computing devices 147 of transport providers 145 and user computing devices 142 of requesting users 140. Each provider computing device 147 can execute a transport service application 149 implemented through execution of instructions stored in one or more memory resources of the provider computing device 147. Likewise, each user computing device 142 can execute a corresponding transport service application 144 implemented through execution of instructions stored in one or more memory resources of the user computing device 142. The service applications 144, 149 may correspond to programs (e.g., a set of instructions or code) or applications (e.g., ‘apps’) that are downloaded and stored on the computing devices 142, 147 of the respective users 140 and transport providers 145. With reference to FIG. 1, the service application 149 executes on the provider device 147 to transmit information that includes a unique identifier of the transport provider 145 and location data indicating the provider's current location. Likewise, the user computing device 142 can execute the service application 144 to initiate a service session and transmit session data comprising a unique identifier of the user 140, location data (e.g., via a GPS module), and contextual information correspond to the user's location and/or behavioral data (e.g., whether the user is indoors or outdoors, stationary, walking, etc.).

In various implementations, the requesting user 140 can operate the computing device 142 to configure and transmit a transport request to the network computing system 100. The user 140 can specify a set of transport service parameters, such as a rendezvous location, a desired destination, and/or other parameters (e.g., a transport service type, such as carpool, standard ride-share, luxury vehicle, food delivery, package delivery, etc.).

In an example of FIG. 1, the system 100 includes a provider device interface 102, a user device interface 104, and a matching engine 106. The provider device interface 102 can establish a connection over one or more networks 135 with the provider devices 147, via execution of the corresponding service application 149. The provider device interface 102 may receive provider data (e.g., a provider identifier, a provider's current location, etc.) using the network connections. In various implementations, the provider device interface 102 and the user device interface 104 can establish connections over the one or more networks 135 with multiple provider devices 147 and user devices 142 concurrently, with the connection to each provider device 147 and user device 142 using one or more wireless networks (e.g., wireless networks, such as a cellular transceiver, a WLAN transceiver, etc.).

In certain aspects, each of the provider and user device interfaces 102, 104 can utilize an application programming interface (API), such as an externally facing API, to communicate data with one or more provider devices 147 and requesting user devices 142, respectively. The externally facing API can provide access to the provider devices 147 and user devices 142 via secure access channels over the network through any number of methods, such as web-based forms, programmatic access via RESTful APIs, Simple Object Access Protocol (SOAP), remote procedure call (RPC), scripting access, and the like.

In some examples, a transport service provider 145 may operate the service application 149 to initiate a transport service session with the system 100, during which the transport provider is available to receive transport invitations and service transport requests from requesting users 140. For example, the transport provider 145 may initiate a service session by toggling a user-interface feature of the service application 149 displayed on the provider device 147. Over the course of a service session, the service provider can be available to receive transport service assignments from system 100. In such examples, the time when the service session of the service provider starts and terminates may thus be selected by the transport service provider 145.

When the transport service provider 145 initiates a service session, the service provider's identifier and current location are communicated to the system 100 via the provider device interface 102. Concurrently, the user device interface 104 can receive session triggers from the user devices 142, which can correspond to the requesting users 140 launching the service application 144. The requesting users 140 can configure and transmit transport requests to system 100, which can be received and processed by the matching engine 106. Based on a configured rendezvous location or the user's current location, the matching engine 106 can identify a set of candidate transport providers 145 to service the transport request. For example, the matching engine 106 can identify a set of transport providers 145 that are within a threshold distance and/or time (e.g., given current traffic conditions) from the user's current location or the configured rendezvous location. From the set of candidate transport providers 145, the matching engine 106 can select a transport provider 145 that matches the user's configurations (e.g., that matches the user's desired transport service type, any preferences or requirements indicated in the transport request, and the like).

The matching engine 106 may then transmit a transport invitation to the provider device 147 of the selected transport provider 145 via the executing service application 149. The selected transport provider 145 may accept or decline the invitation. If accepted, the matching engine 106 can transmit a confirmation to the user device 142 of the requesting user 140 and provide map content indicating an estimated time of arrival and route progress of the transport provider 145 to the rendezvous location. If declined, the matching engine 106 can select a next transport provider 145 in the candidate set, or determine a new set of candidate transport providers 145 and determine a most optimal transport provider 145 from the new set.

According to examples described herein, the service application 144 may display a user interface that includes service related information, as well as other forms of content (e.g., news, promotional offers, etc.). The user device interface 104 may receive, for example, a given transport service request specifying a service start location and destination, as well as other parameters such as a transport service type. When the requesting user 140 submits the transport service request, the request may be deemed open until the transport service request is matched to a transport provider 145. In some variations, the transport provider 145 may also be able to cancel a service request, subject to one or more rules or conditions. For example, the requesting user 140 may be able to cancel a service request at any time preceding when a transport provider 145 is matched, or within a designated duration of time after transmitting the transport request. As another example, the requesting user 140 may cancel the service request subject to a cancellation penalty.

According to some examples, requesting users 140 can cause the service applications 144 on respective computing devices 142 to be launched via selection of the service application 144. When launched, a session trigger can be transmitted to the user device interface 104 and processed by a predictive subsystem 150 of the network computing system 100. For example, location data from the user's computing device 142 can be tracked by a session monitor 110 of the predictive subsystem 150. In some aspects, the requesting user 140 may launch the service application 144 for any one of a variety of reasons, such as to view information about the current state of the transport service, to configure and transmit a transport service request, to review transport service provider availability near the current location of the requesting user 140, or to check status of a transport service request previously transmitted.

For example, the service application 144 can receive, from the system 100, data corresponding to the on-demand transport service, such as an estimated time of arrival of representative driver corresponding to a particular service type (e.g., a carpool driver, a standard ride-share driver, food delivery driver, etc.) to the requesting user's current location. In additional variations, the service application 144 can receive additional data indicating computed costs for each service type based on a set of transport service parameters configured by the user 140 (e.g., a desired destination). The service application 144 can display the information in an interactive user interface, which the user 140 can interact with to make selections and configure transport service requests.

Collectively, real-time contextual session data corresponding to the current session of the user 140 can be received by the session monitor 110, which can identify and track the current location of the user 140 and compile the current session data for execution via a set of discrete models (e.g., machine learning models) each trained or configured for a specific objective of the application-based service. For example, the session monitor 110 can compile real-time data indicating the current location of the user 140, time of day information, and any relevant contextual data (e.g., proximate locales, whether the user 140 is traveling or walking, etc.).

The predictive sub-system 150 can further include a model execution engine 120, which can further compile profile data from a user profile 116 of the requesting user 140. For example, the model execution engine 120 can perform a lookup in a data store 115 of the requesting user's profile 116 to identify predetermined or predefined characterizations of the user 140 based on historical data. For example, the user's interaction with the service application 144, history of transport requests, preferred of frequented service types, and various other data indicating tendencies or preferences of the requesting user 140 can be stored in the user profile 116 of the requesting user 140.

The data store 115 of the predictive sub-system 150 can further store a set of models (e.g., machine learning models) in a model library 118. The model execution engine 120 can run the compiled real-time data and stored profile data of the user 140 through each of the models. As provided herein, each model can score the session data, and can output the session score to a treatment content generator 125. The treatment content generator 125 can select on-app treatment content (e.g., from a content store 127) to be presented to the user 140 via the service application 144.

In various examples, each of the models in the library 118 can represent an objective of the application-based service. For example, one model can represent a desired match rate for the carpool service aspect of the application-based service (e.g., a 95% conversion rate between requests and matched transport providers 145). In such an example, if the carpool service match rate is significantly below the desired rate, the model representing the carpool service match rate can output a relatively high score, which the treatment content generator 125 can process to, for example, push content via the service application 144 indicating a carpool incentive or discount for the requesting user 140. Accordingly, the output score of each model can correlate to whether the objective of that model is being met, exceeded, or not being met. The outputted score can correspond to a degree in which the objective is being exceeded or not being met, which can correspond to a set of local priorities for the application-based service.

According to examples described herein, the transport service region for the application-based service can be parsed into sub-regions (e.g., one kilometer by one kilometer). The predictive sub-system 150 can monitor the marketplace of each of the sub-regions, and data corresponding to the current marketplace conditions may also be run through the set of models 118 (e.g., concurrently with the session data and profile data of the user 140) to output the session scores to the treatment content generator 125. In such examples, the outputted scores can further establish market balance priorities regarding oversupply or undersupply conditions (e.g., supply of available drivers 145 as compared to requesting users 140) in the user's current sub-region and/or proximate sub-regions to the user 140. In reflecting marketplace conditions, the scores outputted by the predictive sub-system 150 can further prioritize marketplace balancing of supply/demand conditions within a set of sub-regions proximate to the user 140 and/or with a global view of marketplace conditions of the entire transport service region.

As an example, the outputted scores of the model execution engine 120 can correlate to priorities that seek to incentivize the user 140 to configure a transport request by engaging the application-based service (e.g., conversion of the user 140 from an observer to an active user-customer), retention or loyalty of the user 140 to the application-based service, marketplace balancing between supply and demand within the sub-region of the user 140 and/or surrounding sub-regions, and/or marketplace balancing for individual service types (e.g., carpool, standard ride-share, luxury vehicle, high capacity vehicle, etc.). Accordingly, as an example, if the user's sub-region is oversupplied with luxury vehicles, the machine learning model representing marketplace balance or match rate for luxury vehicles can output a relatively high score—dependent on contextual session data and profile data individual to the user 140. Given the relatively high score, the treatment content generator 125 may select luxury vehicle incentive content from the content store 127 to present to the user 140 via the executing application 144. The incentive content can correspond to a discounted rate for the luxury vehicle service.

Accordingly, the predictive sub-system 150 can cause treatment content to be displayed to the requesting users 140 with the goal of conversion of the users 140 and marketplace balance of the various transport service types and sub-regions. It is contemplated that the real-time session data and user profile data can further be indicative of the user's intent (e.g., regarding which service type the user 140 is likely to use, a likelihood or probability that the user 140 will convert the session into a requested ride, where the user 140 is likely going, and the like). Further detailed description of the predictive sub-system 150 and the functions of the treatment content generator 125 are provided below with respect to FIG. 1B.

FIG. 1B is a block diagram illustrating a predictive sub-system 150 of a network computing system 100, according to examples described herein. With reference to FIG. 1B, the user predictive sub-system 150 includes a service profile updater 154, a session monitor 156, and a model execution engine 180. The service profile updater 154 may update a usage data store 163 that is maintained and continuously updated for a population of users. The usage data store 163 may include a usage data structure 165 that associates individual users in a population of users, with multiple types of predefined parameters, including, for example, (i) a set of user parameters 167, which characterize information about the user, independent of the user's utilization of the service; (ii) a set of service application parameters 169, which characterize a user's interaction and/or use of the service application 144; and/or (iii) a set of service parameters 171, which characterize a user's utilization of the service (e.g., on-demand transportation service). By way of example, the set of user parameters 167 may include demographic information, including the location where an individual has set as their residence, and contextual data indicating the utilization of the service application 144 by the user 140, and/or real-time session data corresponding to the user's current location and current use of the service application 144.

The set of service application parameters 169 may include parametric values that reflect type, frequency, duration, or pattern of use of activity with respect to the service application 144. By way of example, the set of service application parameters 169 can indicate how often the service application 144 is launched, frequency in which the service application 144 is launched and closed without the user 140 requesting service, duration of time between when service application 144 is launched and user 140 requests service, use of service application 144 for secondary features and purposes, such as in-application messaging or viewing content or promotional material and/or duration of time in which the service application is used over the course of a given time period (e.g., a day or a week, etc.). For transportation services, the user interaction with the service application 144 may also reflect a user's preference for a particular type of transport service, reflecting the service interface the user 140 most often generates a request from, or the service type(s) or interface the user 140 spends the most amount of time (or frequency) viewing (e.g., the amount of time information about a particular type of transport service is presented on the user interface of the service application 144 before the user 140 changes the view, changes to view information about another type(s) of transport service, or providers other input, etc.).

The set of service parameters 171 may include parametric values that reflect type of service requested and/or received, as well as frequency in which service is requested and/or received, amount of service received, and pattern with respect to frequency and amount of service received. In the context of transportation services (e.g., on-demand transportation), the amount of service may reflect, for example, distance traveled, trip times and pricing values. The service parameters 171 reflecting the amount of service may include aggregate values (e.g., average, median, running or weighted average), reflecting values that encompass one or more intervals (e.g., current day, past week, past month, etc.). In the context of food or grocery delivery, the amount of service requested may include, for example, the amount of food orders placed, size of food orders (e.g., number of persons, overall value), and distance traveled from food provider to user 140.

The service profile updater 154 updates the user profile data structure 165, using data received from the session monitor 156. According to some aspects, the service profile updater 154 receives (or retrieves) profile updates 149 from one or more components of system 100, including from the session monitor 156. According to some examples, the service profile updater 154 detects some types of usage events from the session monitor 156 based on the user's interactions with the service application 144. For example, the session data may originate from programmatic processes that run on respective service applications 144 on the user devices 142. The programmatic processes may run to detect user activity, such as the user launching the service application 144 and the user interacting with the user interface displayed via execution of the service application 144 on the user device 142.

In variations, the service profile updater 154 may detect other types of usage events from the session monitor 156, which can monitor the usage data store 163. For example, the service profile updater 154 may receive real-time (or near real-time) information about a user's session, the services received or performed by the user 140, and/or the interaction the user 140 had with respect to the service application 144 or another user.

As an addition or variation, the service profile updater 154 may detect predefined usage events by querying service logs of the active data store 163, application logs maintained by the service application 144 and profile information maintained by profile or accounting resources of the user. The service profile updater 154 may utilize a library of predefined usage events (e.g., based on syntax in application or service logs, responsive to events generated in real-time from the service data store 140 or respective service application 144, etc.) to detect the occurrence of usage events, and to assign value to such usage events based on, for example, contextual information that is detected with or otherwise determined from the usage events.

The model evaluation component 184 enables the predictive sub-system 150 to define and/or modify of treatment content 157, as well as one or more intents 159 which are associated with the treatment content 157. In some examples, treatment content 157 may be created by an operator or partner for a variety of purposes (e.g., creating highly-personalized application features and interface features, converting offers from the operator or partners, researching refinements to features of the service application 144 or service, etc.). According to some examples, the treatment content 157 may be associated with a desired outcome or result, and the optimization (e.g., maximization) of that outcome or result may correspond to the objective of the treatment content 157. By way of example, the treatment content 157 may represent a service communication (e.g., in-app message), service feature, application setting (e.g., which service type should be automatically selected for which user as a default when the application is launched), application configuration, programmatic trigger, or other facet of the application-based service provided by the system 100 through, for example, the service application 144 and/or received and/or performed actions by the respective user, for which predictions of a responsive user action or behavior amongst a group of users is desired. The intent(s) 159 of the service objective may be defined to reflect the desired group of users, based on the objective of the treatment content 157.

Accordingly, the intent(s) 159 of the treatment content 157 represent groupings of users, based on predefined user actions (e.g., user response to a problem or communication, user-initiated action) and behaviors (e.g., repeated user-action over an extended period of time). In some variations, the intent(s) 159 that are defined for each treatment content 157 may reflect both desirable and undesirable groups of users, with desirable groups of users reflecting one or more groups for which the intent is in accordance with the objective of the treatment content 157, and the undesirable groups reflect one or more groups for which the intent is inconsistent or incongruent with the objective of the treatment content 157.

According to some examples, the predictive sub-system 150 utilizes models to identify users (or sets of users) who are more likely (e.g., have a propensity) to respond to treatment content 157 in accordance with a predefined intent (e.g., desirable group). In some implementations, the predictive sub-system 150 may utilize models to identify users who are more likely to respond to the treatment content 157 with an action or behavior that is contrary to the objective of the treatment content 157. As an addition or alternative, individual models may predict a statistically more significant response by type from a group of users within the population, as compared to a random selection of users.

In an example of FIG. 1B, the predictive sub-system 150 includes a model execution engine 180, which may include model training 182, model evaluation 184, a model library 185, and subject selection component 186. As described in greater detail, the model execution engine 180 enables training and selection of models for purpose of selecting users that are more likely to satisfy predefined intent(s) 159 of selected treatment content 157, which may be received or otherwise specified through the session monitor 156. The subject selection component 186 may include a process (or set of processes) that queries (or otherwise scans) the usage data store 163 for users that have specific characteristic profiles, as identified by a model (or set of models). The subject selection component 186 may, for example, specify characteristic profiles that one or more of (i) the user parameters 167, (ii) the service application parameters 169, and/or (iii) the service parameters 171. For a particular set of displayed treatment content 157, the subject selection component 186 may provide the session monitor 156 with a group of users 183. When a trained model is used to select a group of users (“selected group 183”) from the usage data store 163. As described below, the selected group 183 may collectively have a greater number of users that match the intent 159 of the treatment content 157, as compared to a baseline of users. The determination of baseline users may be based on various factors, including, for example, a random selection. The selected group 183 may correspond to a collection of identifiers representing users, such as, for example, unique service identifiers and/or mobile device phone numbers.

The session monitor 156 may initiate a service action (e.g., communication) that corresponds to the treatment content 157 for users that are identified with the selected group 183. In some examples, the treatment content 157 is communicated to individual users of the selected group 183, via the user device interface 104. The system 100 may then monitor the requesting users 140 for a predefined action or behavior. The system 100 may monitor the requesting users 140 via, for example, any one of the programmatic processes on the service application 144, the user device interface 104 and/or session monitor 156.

When a user receives treatment content 157 and acts or behaves in a manner that is consistent with a corresponding predefined intent 159, the user may be said to have converted (e.g., configures a transport request for an indicated service type). A conversion rate may be defined as a ratio that accounts for a total number of users who receive treatment content 157, as compared to a number of those users who act or otherwise exhibit a behavior that is defined by an intent of the service signal 157. For example, the service signal 157 may correspond to a promotional offer that is communicated to a selected group of users. The intent 159 associated with the promotional offer may correspond to users who accept the offer. The conversion rate for the treatment content 157 may be based on the total number of users who received the offer and the total number of users who responded to the offer with an acceptance.

According to some examples, the system 100 may monitor the users who receive the treatment content 157 to determine feedback 175, which may be in the form of detecting conversions 177. The service profile updater 154 may, for example, record conversions 177 with the usage data store 163, and the model execution engine 180 may receive feedback 175 that identifies converted and/or non-converted users for treatment content 157. Based on the feedback 175, the model training 182 may parse the individual characteristic parameters of the monitored users/subjects to identify common characteristics amongst those users who acted in accordance with the defined intent 159 (e.g., those users who accepted the promotional offer), as well as those users who did not respond in accordance with the intent 159 (e.g., those users who did not act on the promotional offer, or those users who affirmatively declined the promotion offer). The model training 182 may adjust weights that the utilized model assigns to specific characteristics represented by, for example, user parameters 167, service application parameters 169, and/or service parameters 171. Through monitoring of users who are identified as subjects of the treatment content 157, the model training 182 may tune a given model to (i) identify and favorably weight those usage profile characteristics (as reflected by the user parameters 167, service application parameters 169, and/or service parameters 171) that are the most correlative to a user group of a defined intent 159; and/or (ii) identify and unfavorably weight those usage profile characteristics (as reflected by the user parameters 167, service application parameters 169, and/or service parameters 171) that are correlative to users who did not convert when the treatment content 157 was received.

In some examples, the model evaluation 184 may determine a baseline for a service objective by, for example, determining a conversion rate for the presented treatment content 157 using a random selection of users. As models are trained, the model evaluation 184 may compare the performance of the models (e.g., the conversion rate) to those of the baseline, in order to evaluate the performance of the respective models. The model evaluation 184 may correlate the performance of individual models with treatment content 157 (e.g., including defining characteristics and objectives of service signals). In some examples, the model execution engine 180 may train and utilize multiple models for given treatment content 157, in order to identify models that perform best for individual sets of treatment content 157.

In some examples, when new treatment content 157 is provided, the model evaluation 184 may compare the characteristics and/or objectives of the newly received treatment content 157 with those of previously deployed treatment content in order to identify one or more similar models which are likely to perform the best in predicting the groups of users with the respective intent(s). Thus, for example, a similarity comparison can be performed to identify treatment content 157 that are similar and thus likely to benefit from use of same models or model types.

Still further, some examples utilize a group of models for treatment content 157. The selection of the group of models (also referred to as “model ensemble”) may be tuned to, for example, performance based on specific characteristics (as represented by parameters of the usage profile data structure 165) in the user base, as well as other factors such as the geographic region or sub-region and/or the time in which the treatment content 157 is deployed and presented to the user 140. The model evaluation 184 may also correlate objectives of select models to characteristics reflected by the parameters of the usage profile data structure 165 in order to enable model selection and ensemble modeling.

In some examples, the predictive sub-system 150 implements a targeting model that includes determining a baseline group, as well as a conversion rate for the baseline group with respect to particular treatment content 157 and intent 159. The targeting model may develop a treatment model for an alternative group of users which share a predetermined set of profile characteristics. In this manner, the targeting model can be developed to predict the conversion rate of a defined treatment group, where the treatment group includes users with a predetermined set of profile characteristics. By way of example, the specific user profile characteristic of the treatment group may be defined by parametric values of the user profiles, such as by a set of user parameters 167, service application parameters 169, and/or service parameters 171. In some examples, the targeting model can also be developed to predict a conversion rate when a given treatment (as provided by the respective treatment content 157 and intent 159) is applied to a particular user group of individuals with a given user profile characteristic (e.g., as defined by user parameters 167, service application parameters 169, and/or service parameters 171).

In some variations, the baseline group can be determined using a separate baseline model. By way of example, the baseline model may predict or otherwise determine a conversion rate that is representative of a larger population of users, while the treatment group may share user profile characteristics which form a subset of the larger population. Once the baseline group of users is determined, the targeting model can predict the difference in conversion rates between a select treatment group of users and the baseline group of users.

In variations, the predictive sub-system 150 can implement a user response model which implements separate models to determine the baseline group, as well as one or multiple treatment groups (e.g., users with alternative characteristics, as defined by parametric value of the respective user profiles). Thus, for example, the user response model can deploy a baseline model on a baseline group of users to predict a conversion rate amongst the baseline set of users. At the same time, one or multiple treatment models may be deployed on alternative treatment groups to predict the conversion rate of specific treatment groups. The conversion rate of one or more multiple treatment groups, as predicted by one or more multiple models, can be compared to the conversion rate of a baseline group, as predicted by a separate baseline model. Thus, the user response model may implement the respective baseline and treatment group models in parallel, and predicted conversion rates of the treatment groups can be compared to those of the baseline group in order to evaluate the respective models. Still further, when a model is developed that is effective for treatment content 157 and intent 159, the particular model may be used to determine the baseline group from which the targeting model may be updated, refined or modified. Over time, increasingly effective baseline models may be determined and associated with characteristics of treatment content 157 and/or intents 159 on which the models were deployed and evaluated. For development of a new or updated targeting model, the determination of the baseline group may include matching characteristics of the target treatment content 157 and/or intent 159 with a prior model that was deemed effective for determining a treatment group for a similar service signal and/or intent.

As another example, an intent model may be used to identify a group of users that have an intent that is highly predictive of a target action. For example, an intent model may identify users who have a propensity to interact with a notification feature (e.g., a notification feature to request transport services when a particular product or service is available). In such an example, the intent model may be used to identify a limited number of users who have a propensity to select a notification feature, as the propensity may be deemed to be highly correlative to users who would use the feature to order a product or service at a given time when prompted. In situations where the objective sought from the intent model is subject to a quota (e.g., offer promotion to five-hundred users), the intent model can identify a group of users (e.g., one thousand users) with the propensity to interact with the notification feature in order to efficiently identify a group of users who will request the product or service without exceeding the quota.

Still further, in some variations, the predictive sub-system 150 may deploy an uplift tree model, which can utilize machine learning techniques of random forest and uplift modeling to predict when a particular treatment (or treatment content 157) yields incremental demand. In such examples, the models may be trained on training data that is split based on a determination of user action that defines incremental demand (e.g., users who will take a particular action as compared to users who will not, given a particular set of presented treatment content 157).

In some variations, the predictive sub-system 150 may be implemented for simulation. For example, the treatment content 157 may correspond to a new or modified functionality. The predictive sub-system 150 may correlate the treatment content 157 to other treatment content in order to predict, for example, a favorability of the feature when deployed to users in the population.

According to various examples, the model library 185 can store a set of models executable on real-time session data 151 received from the user devices 142 via the service application 144. Accordingly, in addition to the above-discussed applications of the treatment content 157, examples described herein can further extend the selection of user groups 183 and/or individual users to receive treatment content based on real-time session data. As described throughout, the real-time session data can include real-time user parameters 167, application parameters 169, and service parameters 171 represented by the usage data structure 165 stored and updated in the usage data store 163. Accordingly, treatment content 157 can be selected and configured for individual users based on their current location, a time of day, a day of the week, current user interactions with the service application 144, and any further contextual data indicated by the user's current location (e.g., whether the user is at home, work, a restaurant, a mall, a music or sporting venue, and the like).

In various examples, the model execution engine 180 can deploy treatment content 157 in accordance with a set of quotas, an incentive budget, and/or marketplace balance stop limits. For example, the application-based service can operate in accordance with incentive programs or budgets to grow the user base and increase user retention. The predictive sub-system 150 can optimize the efficiency of these incentive programs and/or budgets based on the predicted utilization of the application-based service by the users 140 given both the parameters 167, 169, 171 in the usage data structure, and real-time session data. Based on these efficiency optimizations of the incentive programs and/or budgets, the predictive sub-system 150 can provide highly targeted and effective treatment content 157 to select users 140 throughout the transport service region.

Accordingly, the treatment content 157 for individual users may be selected based on multiple competing factors, such as a probability of conversion comprising a calculated probability that the treatment content 157 will be engaged or selected (e.g., as feedback 175) by the user 140 to utilize the application-based service (e.g., request transport based on an incentive provided by the treatment content 157). In addition, each executed model in the model library 185 can output a priority score that indicates a level or sliding scale value in which the objective (e.g., a marketplace balancing objective) represented by the model is being met. In variations, the probability of conversion may be represented within the priority score outputted by the model execution engine 180, given that the real-time session data 151 and profile data of the user 140 are inputted to run on the models.

It is further contemplated that the profile updater 154 can detect whether deployed treatment content 157 to a user 140 results in conversion 177 based on in-app feedback 175 received from the service application 144 executing on the user's computing device 142. Based on the feedback 175 indicating whether the treatment content 157 successfully resulted in conversion 177, the profile updater 154 can update the profile of the user 140. Accordingly, the updated profile data will be run through the models in future iterations (e.g., based on session triggers) of proving treatment content 157 to the user 140, and resulting in additional feedback data 175 and profile updates. Over time, successive profile updates across the entirety of the user base can result in a more robust predictive sub-system 150 with more effective deployment of treatment content 157 to users 140.

Computing Device

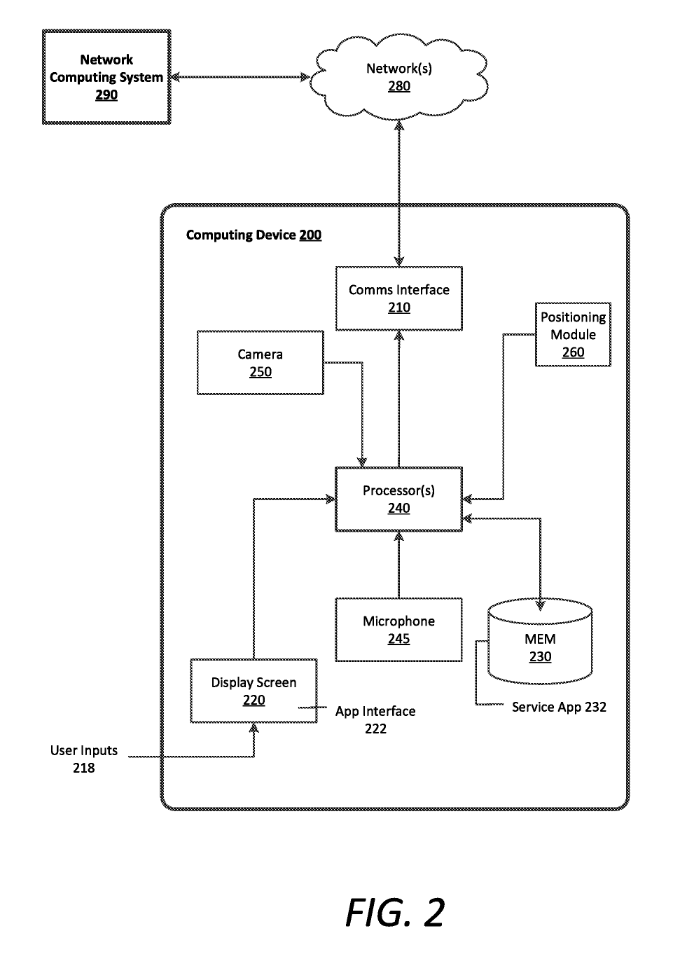

FIG. 2 is a block diagram illustrating an example computing device of a user or transport provider executing a designated transport service application for communicating with a network transport service, according to examples described herein. In many implementations, the computing device 200 can comprise a mobile computing device, such as a smartphone, tablet computer, laptop computer, VR or AR headset device, and the like, and can be controlled by either a human transport provider 145 or a requesting user 140 described with respect to FIG. 1. The computing device 200 can include typical telephony features such as a microphone 245, a camera 250, and a communication interface 210 to communicate with external entities using any number of wireless communication protocols. The computing device 200 can further include a positioning module 260 (e.g., a GPS receiver) that can provide location data to the network computing system 290 upon execution of a service application 232. In certain aspects, the computing device 200 can store a designated application (e.g., a service app 232) in a local memory 230. In the context of FIG. 1, the service app 232 can comprise the service app 144 executable on the user device 142 or the transport service app 149 executable on the transport provider device 147. In variations, the memory 230 can store additional applications executable by one or more processors 240 of the user device 200, enabling access and interaction with one or more host servers over one or more networks 280.

In response to a user input 218, the service application 232 can be executed by a processor 240, which can cause an application user interface 222 to be generated on a display screen 220 of the computing device 200. In addition, execution of the service application 232 can cause a session trigger to be transmitted to the network computing system 290, initiating a service session and network communications with the computing system 290. Over the course of a service session, treatment data may be received from the network computing system 290, which can cause treatment content to be displayed on the application user interface 222. The user can interact with the treatment content as well as with other features displayed on the application interface 222 to interact with the application-based service (e.g., look up current prices, current positions of transport providers, and promotional offers or incentives provided by the treatment content).

The application user interface 222 can enable the user to, for example, configure an on-demand transport request, or display turn-by-turn map directions (e.g., based on route data transmitted by the network computing system 290). In various implementations, the application interface 222 can further enable the user to enter or select a destination location (e.g., by entering an address, performing a search, or selecting on an interactive map). The user can generate the transport request via user inputs 218 provided on the app interface. For example, the user can input a destination and select a transport service option to configure the transport request, and select a request feature that causes the communication interface 210 to transmit the transport request to the network computing system 290 over the one or more networks 280.

As provided herein, the transport service application 232 can further enable a communication link with a network computing system 290 over the network(s) 280, such as the computing system 100 as shown and described with respect to FIG. 1. The processor 240 can generate user interface features (e.g., map, request status, treatment content, etc.) using content data received from the network computing system 290 over the network(s) 280. According to examples provided herein, selection or interaction with the treatment content can cause the incentives and/or promotional content to be activated and applied to a configured transport request. Based on such activation, the resultant transport request can be transmitted to the network computing system 290, which can apply the incentive indicated in the treatment content to the resultant serviced trip for the user. Furthermore, the network computing system 290 can update the user profile of the user to indicate that the treatment content resulted in conversion.

The processor 240 can transmit the transport requests via a communications interface 210 to the backend network computing system 290 over the network 280. In response, the computing device 200 can receive a confirmation from the network system 290 indicating the selected transport provider that will service the request and that any incentive activated in the treatment content will be applied to the trip. In various examples, the computing device 200 can further include a positioning module 260, which can provide location data indicating the current location of the requesting user to the network system 290 to, for example, determine the rendezvous location.

In various examples, the treatment content displayed on the display screen 220 can further comprise recommendations or suggestions based on the real-time session data provided by the computing device 200 (e.g., locale recommendations based on user reviews and/or popularity). In certain implementations, the treatment content can further include additional content, such as notifications of general promotions, educational or news material, gaming content, images, video content, and the like.

Methodology

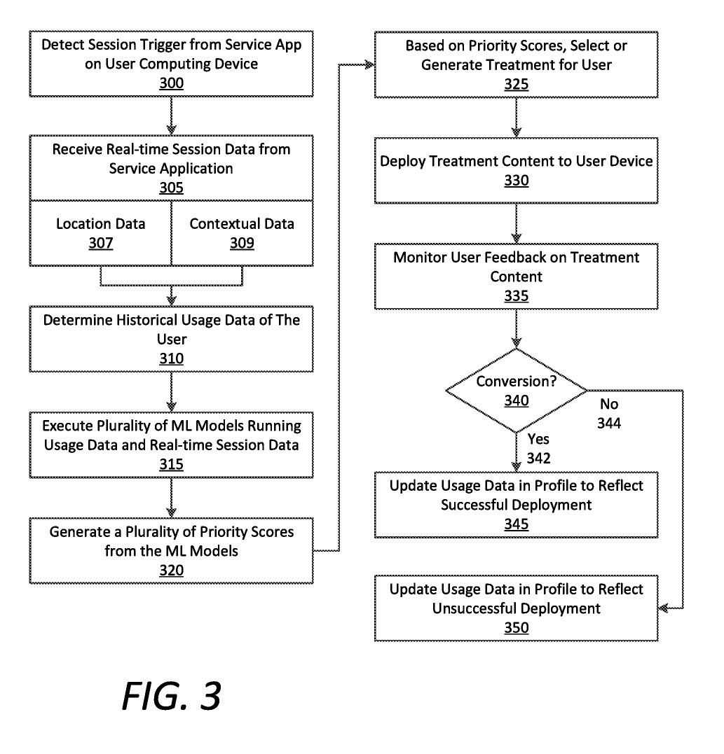

FIG. 3 is a flow chart describing example method of implementing an application-based service utilizing deployed treatment content, according various examples described herein. In the below description of FIG. 3, reference may be made to reference characters representing like features as shown and described with respect to FIGS. 1A, 1B, and 2. Furthermore, the processes described in connection with FIG. 3 may be performed by an example network computing system 100 implementing a predictive sub-system 150 as shown and described with respect to FIGS. 1A and 1B. Referring to FIG. 3, the network computing system 100 can detect a session trigger from the service application 144 executing on a user device 142 (300). Based on the session trigger, the system 100 can receive real-time session data from the service application 144 (305). As provided herein, the real-time session data can include location data of the user (307). In additional, the real-time session data can include contextual information corresponding to the user 140 (309). As described, the contextual data can indicate a locale at which the user is currently located, (e.g., whether the user 140 is at a home location, work, a restaurant, a store or mall, sporting venue, concert venue, etc.). The contextual data can also indicate whether the user 140 currently traveling, data indicating the user's intent (e.g., to request transport or whether the user is merely browsing services and/or prices), in-app usage behavior, and the like.

In various examples, the system 100 can determine stored or historical usage data of the user (310). For example, the system 100 can perform a lookup of the user's profile 116 in a data store 115 to identify the user, application, and service parameters 167, 169, 171 that (i) characterize information about the user, independent of the user's utilization of the service, (ii) characterize the user's interaction and/or use of the service application 144, and (iii) characterize the user's utilization of the application-based service. In various examples, the system 100 can execute a plurality of models from a model library 118 (e.g., machine learning models), each model running the usage data and the real-time session data (315).

In various examples, the system 100 can determine a plurality of priority scores outputted from the models (320). As described herein, the priority scores can provide an indication of the likelihood or probability that treatment content 157 corresponding to a particular model will result in conversion. In further examples, the priority scores can also indicate a level at which the objective corresponding to the model is being met. For example, the priority score can indicate whether a particular transport service (e.g., carpool sharing) is oversupplied or undersupplied in the sub-region of the user 140.

Based on the priority scores from the models, the system 100 can select or generate treatment content 157 for the user 140 (325), and deploy the treatment content 157 to the user device 142 via the service application 144 (330). In deploying the treatment content 157, the system 100 can transmit content data that causes the user interface 222 of the service application 144 to display or overlay interactive features on application content, which can provide the user 140 with information corresponding to the treatment content 157 (e.g., a promotional offer or incentive to utilize a particular transport service option, such as carpool ride sharing).

The system 100 may then monitor feedback 175 from the service application 144 indicating whether the user 140 interacts with the treatment content 157 (335). Based on the feedback 175, the system 100 can determine whether the user 140 has converted from an observer to a requesting user of the transport service (340). In other words, the system 100 can determine whether the treatment content 157 has caused the user 140 to engage the service application 144 in order to request an application-based service (e.g., a particular transport service corresponding to the treatment content 157). If so (342), the system 100 can update the usage data in the user's profile 116 to reflect the successful deployment of the treatment content 157 to the user 140 (345). However, if not (344), the system 100 can update the usage data in the user's profile 116 to reflect the unsuccessful deployment of the treatment content 157 (350). Whether successful or unsuccessful, over time, the models can provide a more robust and effective in-app treatment for the user 140 and the application-based service with each successive deployment of treatment content 157 to the user 140.

Hardware Diagram

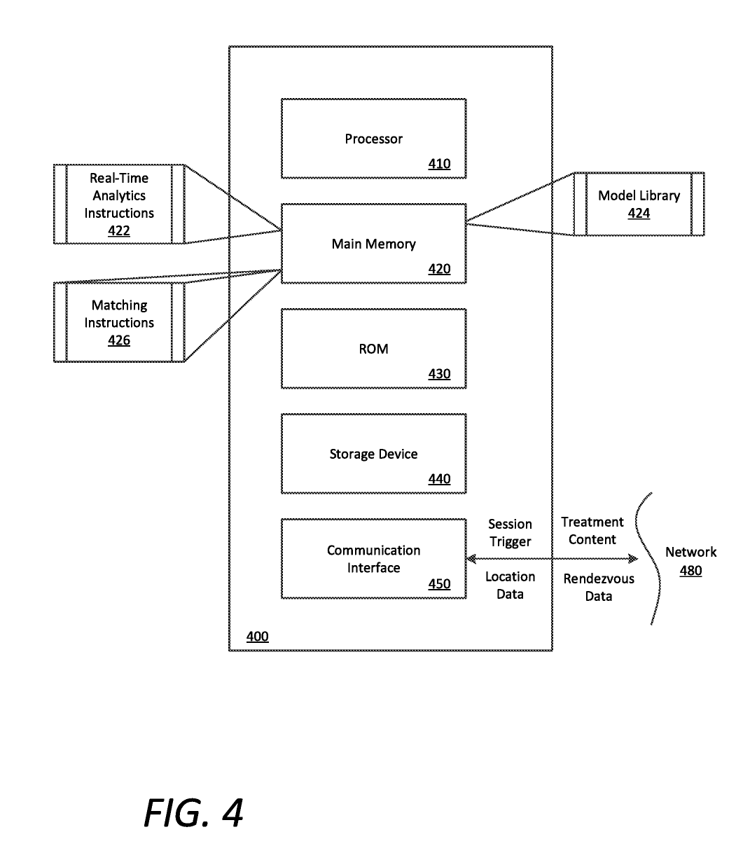

FIG. 4 is a block diagram that illustrates a computing system upon which examples described herein may be implemented. A computing system 400 can be implemented on, for example, a server or combination of servers. For example, the computing system 400 may be implemented as part of a network service, such as described in FIGS. 1 and 2. In the context of FIG. 1, the network computing system 100 may be implemented using a computing system 400 such as described by FIG. 4. The network computing system 100 may also be implemented using a combination of multiple computing systems as described in connection with FIG. 4.

In one implementation, the computing system 400 includes processing resources 410, a main memory 420, a read-only memory (ROM) 430, a storage device 440, and a communication interface 450. The computing system 400 includes at least one processor 410 for processing information stored in the main memory 420, such as provided by a random-access memory (RAM) or other dynamic storage device, for storing information and instructions which are executable by the processor 410. The main memory 420 also may be used for storing temporary variables or other intermediate information during execution of instructions to be executed by the processor 410. The computing system 400 may also include the ROM 430 or other static storage device for storing static information and instructions for the processor 410. A storage device 440, such as a magnetic disk or optical disk, is provided for storing information and instructions.

The communication interface 450 enables the computing system 400 to communicate with one or more networks 480 (e.g., cellular network) through use of the network link (wireless or wired). Using the network link, the computing system 400 can communicate with one or more computing devices, one or more servers, one or more databases, and/or one or more self-driving vehicles. In accordance with examples, the computing system 400 receives transport requests from mobile computing devices of individual users. The executable instructions stored in the memory 430 can include matching instructions 426, which the processor 410 executes to match a requesting user with a transport provider, and provide rendezvous data to the user and transport provider, as described herein.

The executable instructions stored in the memory 420 can also include real-time analytics instructions 422, which the processor 410 can execute to receive a session trigger corresponding to the launch of the service application on user devices, process real-time session data (e.g., location and contextual data) and stored usage data of a user through a plurality of models stored in a model library 424. Based on outputted scores from the models, the real-time analytics instructions 422 can cause the processor to output data that causes treatment content to be displayed on user devices of selected users.

Examples described herein relate to the use of the computing system 400 for implementing the techniques described herein. According to one example, those techniques are performed by the computing system 400 in response to the processor 410 executing one or more sequences of one or more instructions contained in the main memory 420. Such instructions may be read into the main memory 420 from another machine-readable medium, such as the storage device 440. Execution of the sequences of instructions contained in the main memory 420 causes the processor 410 to perform the process steps described herein. In alternative implementations, hard-wired circuitry may be used in place of or in combination with software instructions to implement examples described herein. Thus, the examples described are not limited to any specific combination of hardware circuitry and software.

It is contemplated for examples described herein to extend to individual elements and concepts described herein, independently of other concepts, ideas or systems, as well as for examples to include combinations of elements recited anywhere in this application. Although examples are described in detail herein with reference to the accompanying drawings, it is to be understood that the concepts are not limited to those precise examples. As such, many modifications and variations will be apparent to practitioners skilled in this art. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude claiming rights to such combinations.

What is claimed is:

1. A computing system implementing an application-based service for a service region, the computing system comprising:
a network communication interface enabling network communications with computing devices of one or more users of the application-based service;
one or more processors; and
a memory storing instructions that, when executed by the one or more processors, cause the computing system to:
detect, via the network communication interface, a session trigger corresponding to execution of a service application on a computing device of a user, the session trigger initiating a user session of the application-based service;
execute one or more of a plurality of models corresponding to a unique objective for the application-based service, each model running real-time session data corresponding to the user session;
generate, from each model of the plurality of models, a session score indicating a priority level for the unique objective corresponding to the model; and
based on the session score from each of the plurality of models, transmit treatment data to the computing device of the user, the treatment data causing treatment content to be displayed on the computing device of the user.

2. The computing system of claim 1, wherein the application-based service comprises a plurality of transport service types, and wherein the unique objective for each of the plurality of models represents transport supply versus transport demand for a respective one of the plurality of transport service types.

3. The computing system of claim 1, wherein the real-time session data comprises a current location of the user.

4. The computing system of claim 1, wherein the real-time session data comprises a current time of day.

5. The computing system of claim 1, wherein the treatment content comprises one or more service incentives for the user in utilizing the application-based service.

6. The computing system of claim 5, wherein the executed instructions cause the computing system to select the treatment content for display on the computing device of the user based on a set of stop limits to the one or more service incentives.

7. The computing system of claim 1, wherein the executed instructions further cause the computing system to:
run usage data through the plurality of models concurrently with the real-time session data, the usage data characterizing historical utilization of the application-based service by the user.

8. The computing system of claim 7, wherein the session score of each of the plurality of model further accounts for the usage data of the user.

9. The computing system of claim 1, wherein the executed instructions further cause the computing system to:
monitor feedback data from the computing device of the user, the feedback data indicating a user response to the treatment content; and
determine whether the treatment content causes the user to engage the application-based service.

10. A non-transitory computer-readable medium storing instructions that, when executed by one or more processors of a computing system, cause the computing system to:
detect, via a network communication interface, a session trigger corresponding to execution of a service application on a computing device of a user, the session trigger initiating a user session of an application-based service;
execute one or more of a plurality of models corresponding to a unique objective for the application-based service, each model running real-time session data corresponding to the user session;
generate, from each model of the plurality of models, a session score indicating a priority level for the unique objective corresponding to the model; and
based on the session score from each of the plurality of models, transmit treatment data to the computing device of the user, the treatment data causing treatment content to be displayed on the computing device of the user.

11. The non-transitory computer-readable medium of claim 10, wherein the application-based service comprises a plurality of transport service types, and wherein the unique objective for each of the plurality of models represents transport supply versus transport demand for a respective one of the plurality of transport service types.

12. The non-transitory computer-readable medium of claim 10, wherein the real-time session data comprises a current location of the user.

13. The non-transitory computer-readable medium of claim 10, wherein the real-time session data comprises a current time of day.

14. The non-transitory computer-readable medium of claim 10, wherein the treatment content comprises one or more service incentives for the user in utilizing the application-based service.

15. The non-transitory computer-readable medium of claim 14, wherein the executed instructions cause the computing system to select the treatment content for display on the computing device of the user based on a set of stop limits to the one or more service incentives.

16. The non-transitory computer-readable medium of claim 10, wherein the executed instructions further cause the computing system to:
run usage data through the plurality of models concurrently with the real-time session data, the usage data characterizing historical utilization of the application-based service by the user.

17. The non-transitory computer-readable medium of claim 16, wherein the session score of each of the plurality of model further accounts for the usage data of the user.

18. The non-transitory computer-readable medium of claim 10, wherein the executed instructions further cause the computing system to:
monitor feedback data from the computing device of the user, the feedback data indicating a user response to the treatment content; and
determine whether the treatment content causes the user to engage the application-based service.

20. A method of implementing an application-based service, the method being performed by one or more processors and comprising:
detecting, via a network communication interface, a session trigger corresponding to execution of a service application on a computing device of a user, the session trigger initiating a user session of an application-based service;
executing one or more of a plurality of models corresponding to a unique objective for the application-based service, each model running real-time session data corresponding to the user session;
generating, from each model of the plurality of models, a session score indicating a priority level for the unique objective corresponding to the model; and
based on the session score from each of the plurality of models, transmitting treatment data to the computing device of the user, the treatment data causing treatment content to be displayed on the computing device of the user.
